(19) United States
(12) Patent Application Publication
(10) Pub. No.: US 2005/0076348 A1
(43) Pub. Date: Apr. 7, 2005

(54) Optical disc drive having a disc transport tray moved by a spindle motor

(76) Inventor: Xiao-Ning Sun, Suzhou (CN)

Correspondence Address: RABIN & Berdo, PC, 1101 14TH STREET, NW, SUITE 500, WASHINGTON, DC, 20005, US

(21) Appl. No.: 10/958,257

(22) Filed: Oct. 6, 2004

(30) Foreign Application Priority Data
Oct. 7, 2003 (TW) 92127889

(51) Int. Cl. G11B 17/03; G11B 17/04; G11B 33/02

(52) U.S. Cl. 720/608

(57) ABSTRACT

An optical disc drive having a tray moved by the spindle motor is disclosed. The optical disc drive at least comprises a chassis, a tray, a spindle motor, a transmission chain and a coupling apparatus. The tray is mounted on the chassis for carrying a disc. The spindle motor is used for rotationally driving the disc. The transmission chain is used for moving the tray. The coupling apparatus selectively couples the transmission chain and the spindle motor. When the coupling apparatus is started, the transmission chain is coupled to the spindle motor, and the power generated from the spindle motor is transmitted to the tray through the transmission chain, so as to power the movement of tray for in-and-out of the optical disc drive. Thus, the invention does not require a conventional tray motor, so as to decrease the production cost.

This application claims the benefit of Taiwan application Serial No. 092127889, filed Oct. 7, 2003, the subject matter of which is incorporated herein by reference.

### BACKGROUND OF THE INVENTION

1. Field of the Invention

The invention relates in general to an optical disc drive, and more particularly to an optical disc drive having a disc transport tray moved by a spindle motor.

2. Description of the Related Art

An optical disc drive typically comprises at least a spindle motor and a tray motor. A disc transport tray on which a disc is placed is rotationally driven by the spindle motor, for operation of the optical head to read or write information on the disc. The movement of disc transport tray outside or within the optical disc drive is driven by the tray motor, for loading the disc on the tray or removing the disc from the tray.

However, the spindle motor and the tray motor don't rotate at the same time. Normally, when the user press the switch on the control board of the disc drive for trying to take the disc out of the optical disc drive, the spindle motor stops rotating first, and then the tray motor starts operating for moving the tray outward so the disc can be removed. Similarly, when the user places a disc on the tray and press the switch on the control board of the disc drive, the tray motor starts operating to move the tray into the disc drive, and then the spindle motor starts operating to rotate the disc for reading/writing information on the disc.

In the prior art design, the spindle motor and the tray motor don't rotate simultaneously. If the rotation motion of the spindle motor can be used to power the movement of the disc transport tray, the tray motor won't be needed and the cost of the optical disc drive will be reduced.

### SUMMARY OF THE INVENTION

It is therefore an object of the invention to provide an optical disc drive having a tray moved by the spindle motor. The mechanism design of the invention transmits the rotation power of the spindle motor to the power of the movement of the tray. The mechanism design at least comprises a transmission chain and a coupling apparatus. Thus, the invention of using the spindle motor power the movement of the tray does not require the conventional tray motor, so as to decrease the production cost.

The invention achieves the objects by providing an optical disc drive having a tray moved by the spindle motor. The optical disc drive at least comprises a chassis, a tray, a spindle motor, a transmission chain and a coupling apparatus. The tray is mounted on the chassis for carrying a disc. The spindle motor is used for rotationally driving the disc. The transmission chain is used for moving the tray. The coupling apparatus selectively couples the transmission chain and the spindle motor. When the coupling apparatus is started, the transmission chain is coupled to the spindle motor, and the power generated from the spindle motor is transmitted to the tray through the transmission chain, so as to power the movement of tray for in and out of the optical disc drive.

The invention achieves the objects by providing a method for moving a tray in-and-out of an optical disc drive by a spindle motor. The optical disc drive comprises a chassis, the tray, the spindle motor, a transmission chain and a coupling apparatus. The tray is mounted on the chassis for carrying a disc, the spindle motor is used for rotationally driving the disc, the transmission chain is used for moving the tray, and the coupling apparatus selectively couples the transmission chain and the spindle motor. The method comprises steps of: (a) operating the coupling apparatus, to couple the transmission chain and the spindle motor; and (b) rotating the spindle motor, to drive the transmission chain, so that the transmission chain driving the tray for moving in-and-out of the optical disc drive.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded view of optical disc drive showing the spindle motor used to power the movement of the disc transport tray according to the preferred embodiment of the invention.

FIG. 2A is a side view of the disassembled optical disc drive of FIG. 1, taken as indicated by X-Z plane of FIG. 1.

FIG. 2B is another side view of the disassembled optical disc drive of FIG. 1, taken as indicated by Y-Z plane of FIG. 1.

FIG. 3A is a side view showing a portion of the optical disc drive of FIG. 1 at the condition of the electromagnet not being electrified, taken as indicated by Y-Z plane of FIG. 1.

FIG. 3B is a bottom view showing a portion of the optical disc drive of FIG. 1 at the condition of the electro-magnet not being electrified, taken as indicated by X-Y plane of FIG. 1.

FIG. 3C is a front view showing a portion of the optical disc drive of FIG. 1 at the condition of the electro-magnet not being electrified, taken as indicated by X-Z plane of FIG. 1.

FIG. 3D is a top view showing a portion of the optical disc drive of FIG. 1 at the condition of the electromagnet not being electrified, taken as indicated by X-Y plane of FIG. 1.

FIG. 4A is a side view showing a portion of the optical disc drive of FIG. 1 at the condition of the electromagnet being electrified, taken as indicated by Y-Z plane of FIG. 1.

FIG. 4B is a bottom view showing a portion of the optical disc drive of FIG. 1 at the condition of the electromagnet being electrified, taken as indicated by X-Y plane of FIG. 1.

FIG. 5A˜FIG. 5D respectively show the side view, bottom view, front view and top view of a portion of the optical disc drive, after the tray and the rocker-arm of FIG. 3A˜FIG. 3D being removed.

FIG. 6 is a side view showing a portion of the optical disc drive, after the tray and the rocker-arm of FIG. 4A being removed.

FIG. 7 is a bottom view of the disc transport tray.

FIG. 8A˜FIG. 8E illustrate the relative positions of the cam block and the tray slot when the tray being moved in or out of the optical disc drive.

### DETAILED DESCRIPTION OF THE INVENTION

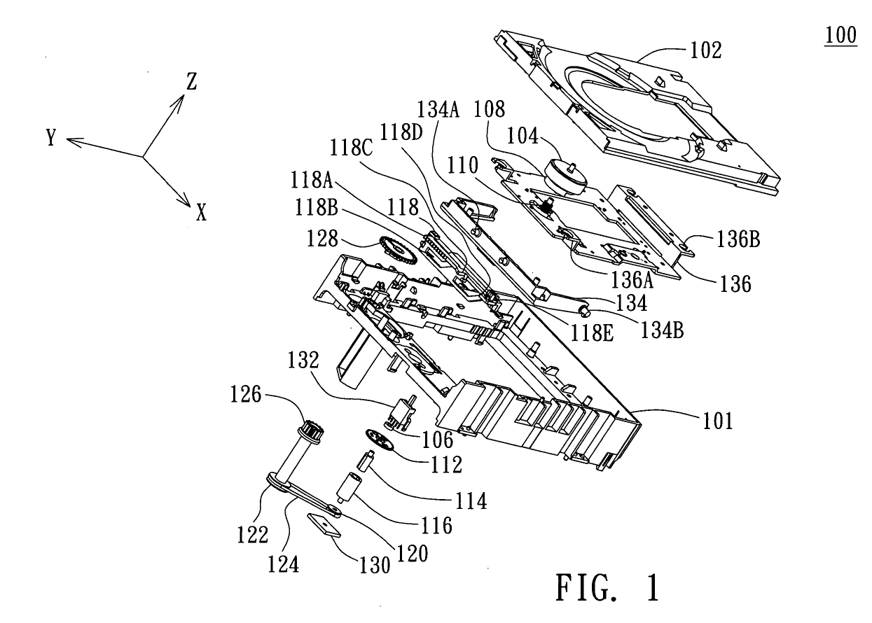

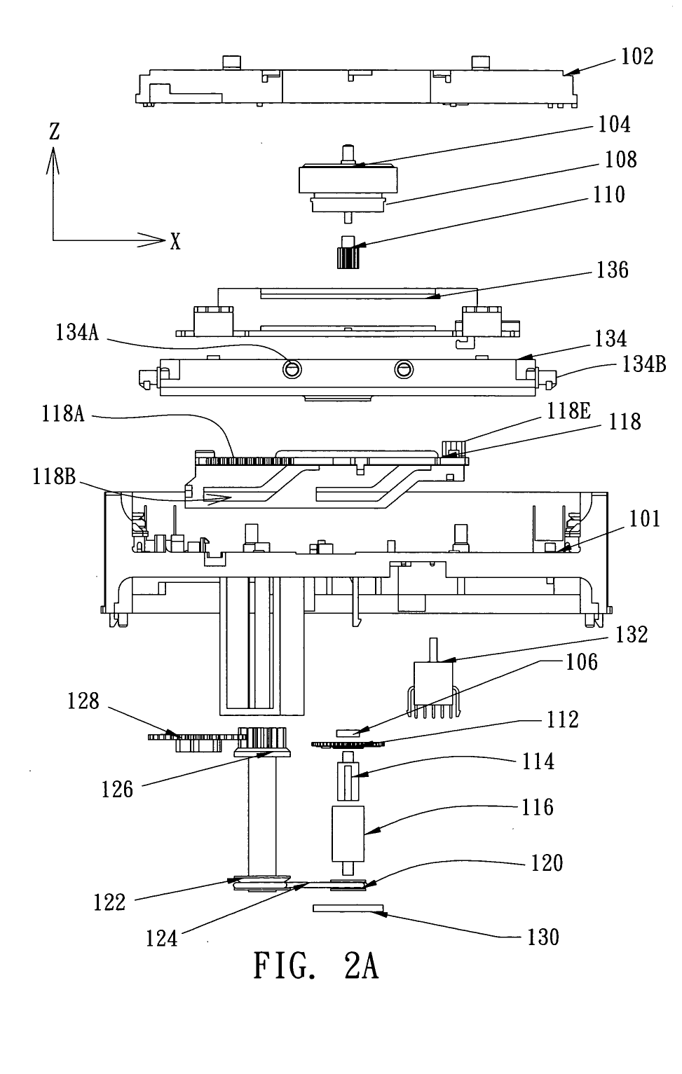

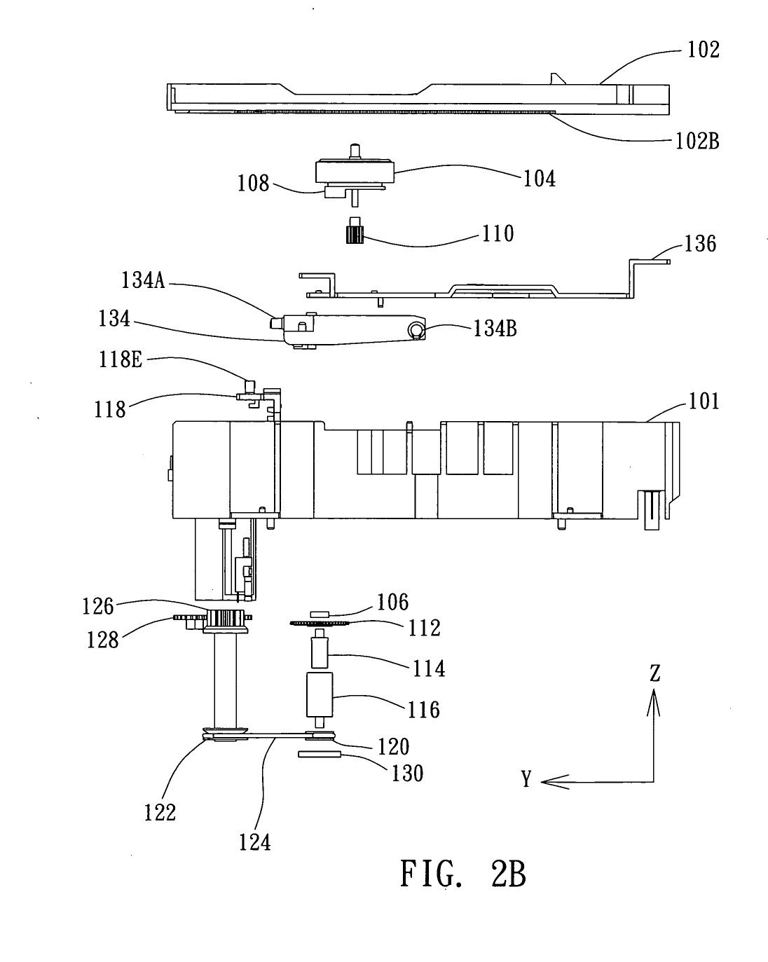

FIG. 1 is an exploded view of optical disc drive showing the spindle motor used to power the movement of the disc transport tray according to the preferred embodiment of the invention. FIG. 2A is a side view of the disassembled optical disc drive of FIG. 1, taken as indicated by X-Z plane of FIG. 1. FIG. 2B is another side view of the disassembled optical disc drive of FIG. 1, taken as indicated by Y-Z plane of FIG. 1. An optical transport tray 100 comprises a chassis 101, a disc transport tray 102, a spindle motor 104, a transmission chain, and a coupling apparatus. Most components of the optical disc drive are mounted on the chassis 101, and the tray 102 is positioned above the chassis 101 for carrying a disc (not shown in FIG. 1). The disc is rotationally driven by the spindle motor 104. The transmission chain is used for moving the tray 102. The coupling apparatus is used to selectively couple the transmission chain and the spindle motor 104. When the coupling apparatus is started, the transmission chain is coupled to the spindle motor 104, and the power generated from the spindle motor 104 is transmitted to the tray 102 through the transmission chain, so as to power the movement of tray 102 for in and out of the optical disc drive.

The optical disc drive 100 further has a first transmitting component, such as a first gear 110, which is mounted on the shaft of the spindle motor 104 and rotated by the spindle motor 104. The coupling apparatus includes a magnetic-permeability component and an elecro-magnet 108. A gag-bit 106, which is not magnetized, could be used as the high-permeability component. The gag-bit 106 is coupled to the transmission chain, but not pivoted on the central axis. The elecro-magnet 108 is coupled to the spindle motor 104, and selectively attracts the gag-bit 106. The transmission chain includes a second transmitting component, a retractable part and a driving mechanism. A second gear 112 could be used as the second transmitting component. The retractable part could be a shaft 114 and a sleeve 116 which are coaxially rotated. Also, the shaft 114 is coaxially connected to the second gear 112. The shaft 114 is placed within and coaxially rotated with the sleeve 116. The shaft 114 is able to slide upward and downward within the sleeve 116; also, the shaft 114 can be separated from the sleeve 116 or inserted in the sleeve 116. The gag-bit 106 mounted on the upper end of the shaft 114 is also used to attach the second gear 112 on the upper end of the shaft 114. The lower end of the sleeve 116 is connected to the driving mechanism.

The optical disc drive 100 further has a cam 118, which is used to drive the spindle motor 104 to move upward and downward on the direction vertical to the tray 102. The cam 118 comprises a cam rack 118A, two cam slots 118B, a first protrusion 118C, a second protrusion 118D and a cam block 118E. Moreover, the driving mechanism comprises a first belt pulley 120, a second belt pulley 122, a belt 124, a cam gear 126, a tray gear 128 and an axis base 130. The first belt pulley 120 is mounted on the lower end of the sleeve 116, and positioned between the sleeve 116 and the axis base 130. The second belt pulley 122 is coupled to the first belt pulley 120 through the belt 124. The cam gear 126 coupled to the tray gear 128 is coaxially connected to the second belt pulley 122. Also, the cam gear 126 selectively engages the cam rack 118A. The sleeve 116 is fixed on the axis base 130.

The optical disc drive 100 further comprises a control switch 132, a rocker-arm 134 and a mounting plate 136. The control switch 132 is triggered by the first protrusion 118C or the second protrusion 118D of the cam 118. The rocker-arm 134 has two front pins 134A and two side axles 134B. Each front pin 134A is coupled to the cam slot 118B of the cam 118. The side axles 134B are coupled to two surfaces of the chassis 101, respectively. The spindle motor 104 and an optical reading system (not shown) are positioned on the mounting plate 136. The front end of the mounting plate 136 is secured on the rocker-arm 134 by the positioning components 136A. The rear end of the mounting plate 136 is connected to the chassis 101 through the positioning components 136B.

When the cam 118 is moved back and forth in the direction of X, the front pins 134A slide along the cam slots 11 8B so as to revolve the rocker-arm 134 on the side axles 134B. The swing of the rocker-arm 134 also makes the mounting plate 136 swing, by using the positioning components 136A as the fulcrum. When the mounting plate 136 is swing, the spindle motor 104 is also moved up and down along the direction of Z.

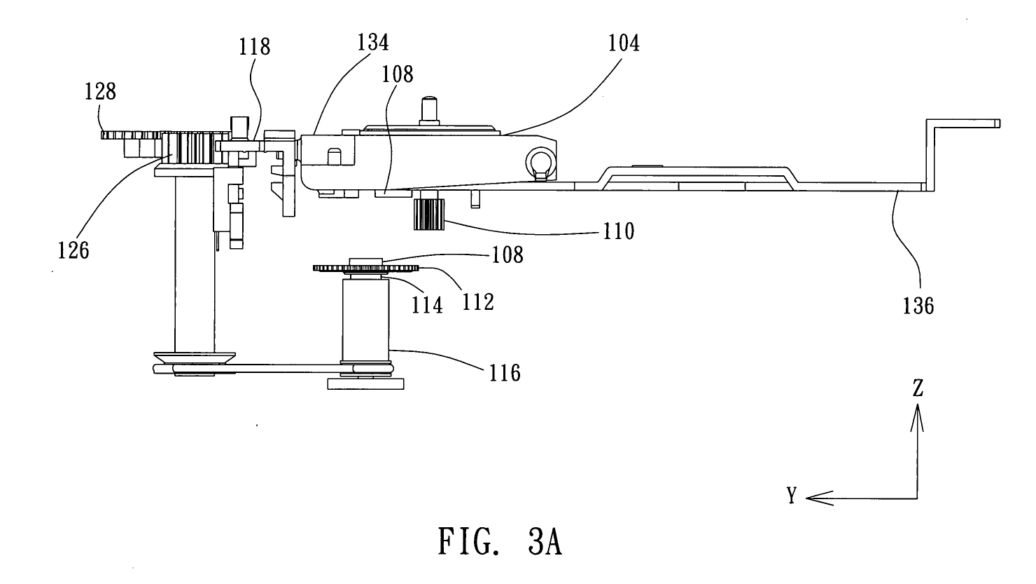

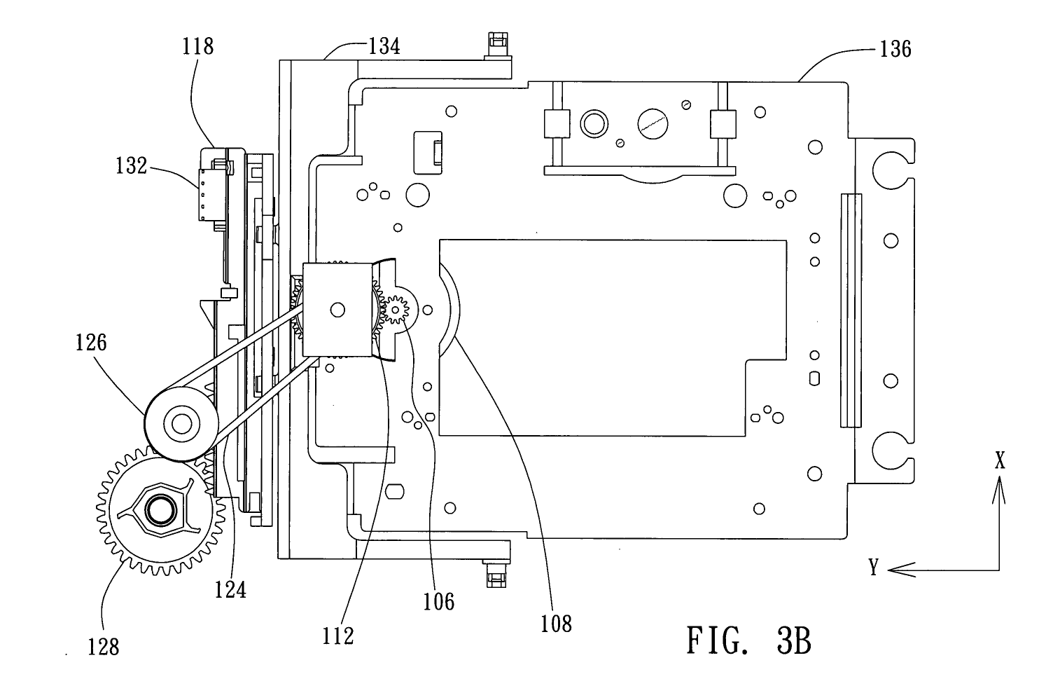

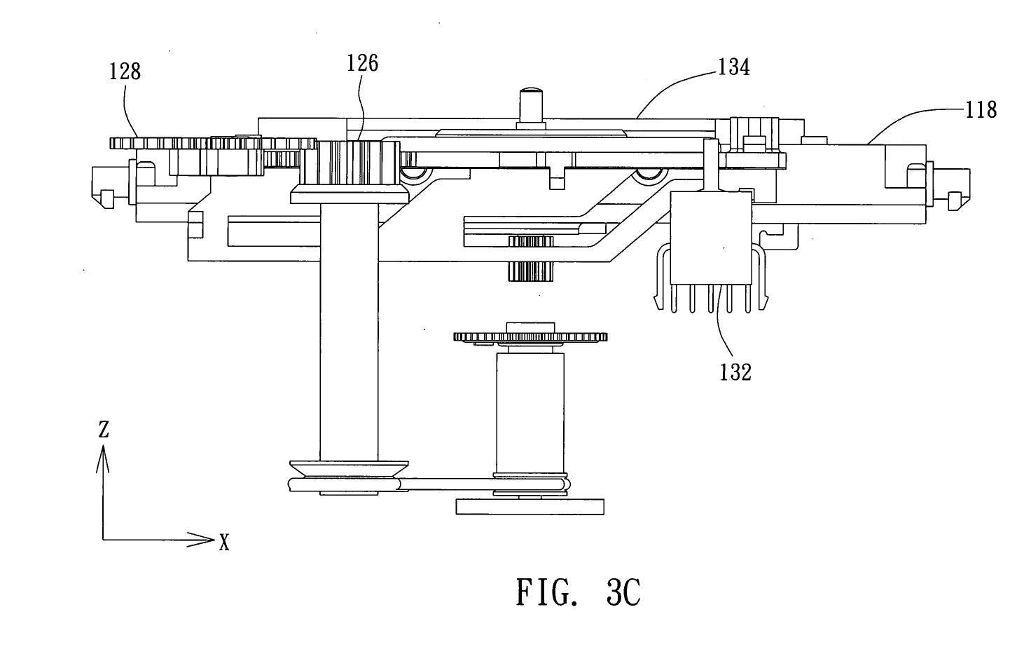

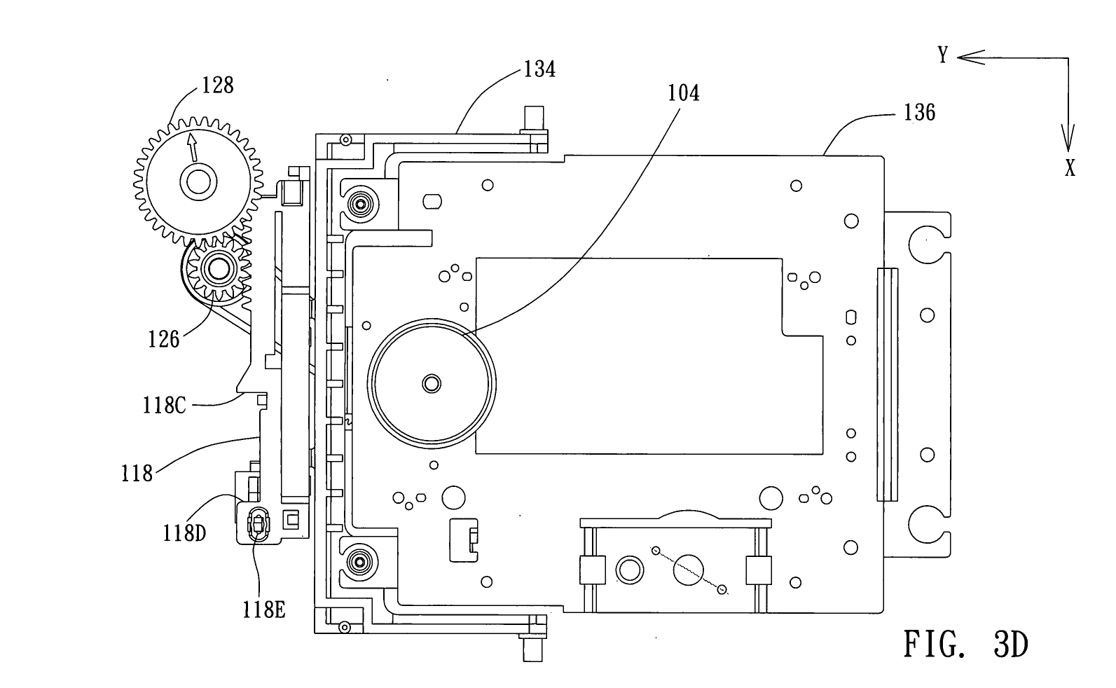

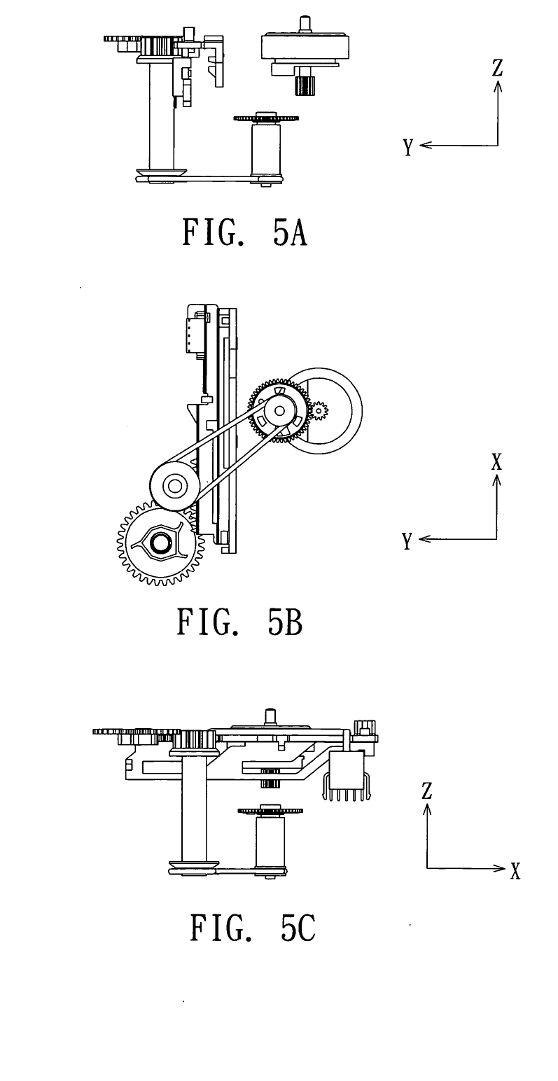

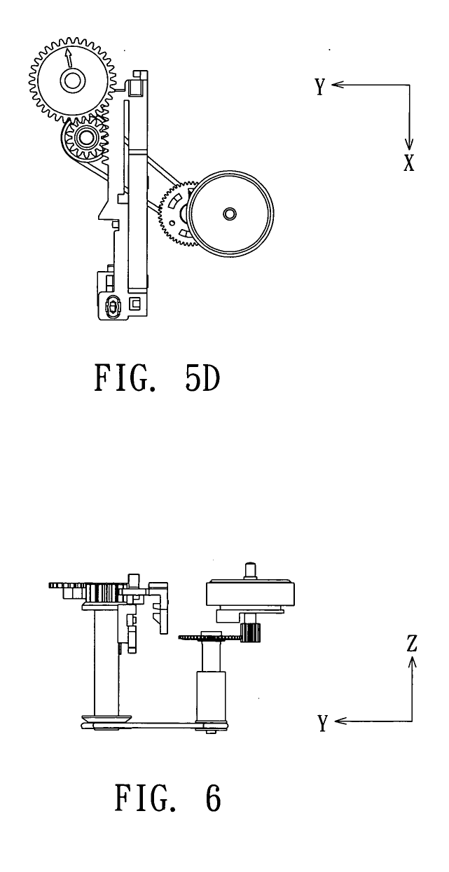

Please refer FIGS. 3A˜3D and 5A˜5D. FIG. 3A is a side view showing a portion of the optical disc drive of FIG. 1 at the condition of the electro-magnet not being electrified, taken as indicated by Y-Z plane of FIG. 1. At the same condition, FIG. 3B is a bottom view, taken as indicated by X-Y plane of FIG. 1; FIG. 3C is a front view, taken as indicated by X-Z plane of FIG. 1; FIG. 3D is a top view, taken as indicated by X-Y plane of FIG. 1. FIGS. 5A˜5D respectively show the side view, bottom view, front view and top view of a portion of the optical disc drive, after the tray 136 and the rocker-arm 134 of FIGS. 3A˜3D being removed. When the eletro-magnet 108 is un-electrified, there is no magnetism exhibited on the eletro-magnet 108, so that the gag-bit 106 is not attracted to the eletro-magnet 108; meanwhile, the shaft 114 is completely received in the sleeve 116, and the second gear 112 disengages from the first gear 110. The disc loaded on the tray 102 is rotationally driven by the spindle motor 104.

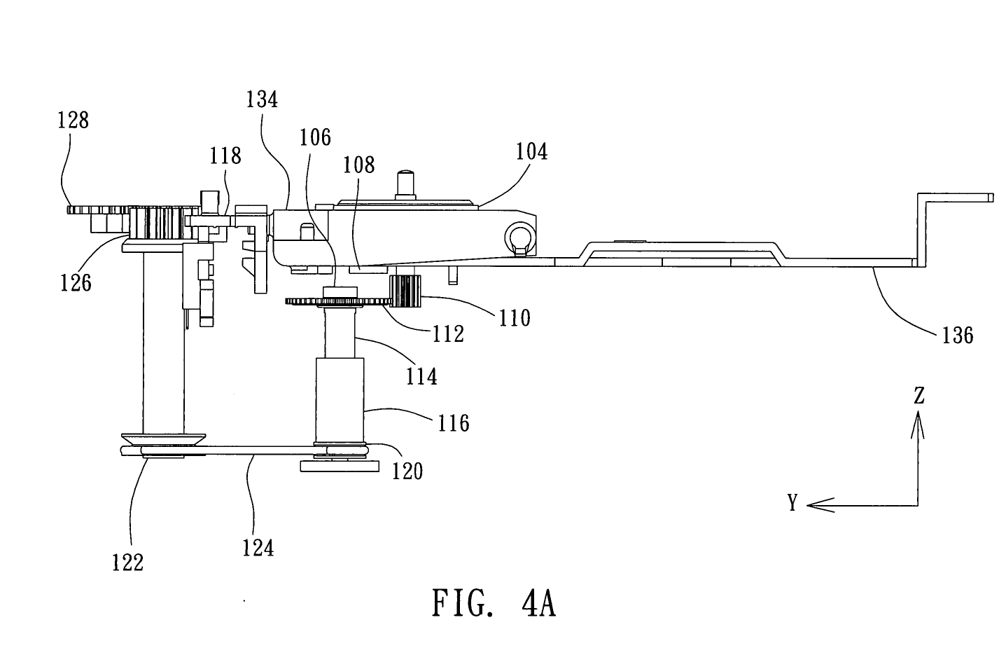

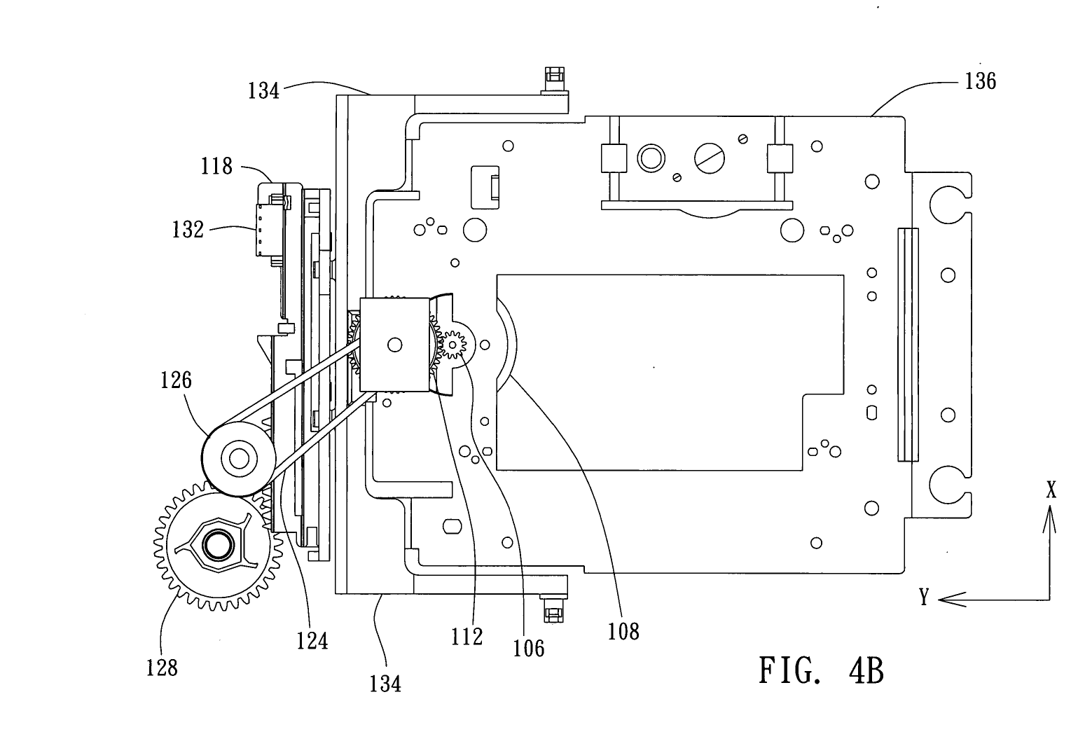

Please refer FIGS. 4A˜4B and FIG. 6. FIG. 4A is a side view showing a portion of the optical disc drive of FIG. 1 at the condition of the electromagnet being electrified, taken as indicated by Y-Z plane of FIG. 1. FIG. 4B is a bottom view showing a portion of the optical disc drive of FIG. 1 at the condition of the electromagnet being electrified, taken as indicated by X-Y plane of FIG. 1. FIG. 6 is a side view showing a portion of the optical disc drive, after the tray 136 and the rocker-arm 134 of FIG. 4A being removed. When the eletro-magnet 108 is electrified, magnetism exhibited on the eletro-magnet 108 attracts the gag-bit 106 so as to change the length of the retractable part (consisting of the shaft 114 and the sleeve 116). That is part of the shaft 114 being pulled off the sleeve 116, and the overall length of the retractable part being increased. Meanwhile, the second gear 112 engages the first gear 110. When the spindle motor 104 starts to operate, the first gear 110 driven by the spindle motor 104 drives the second gear 112, the shaft 114 and the sleeve 116. Thus, the driving mechanism (consisting of the first and second belt pulley 120, 122, the belt 124, the cam gear 126, the tray gear 128 and the axis base 130) is operated by the sleeve 116 and drive the tray 102 in and out of the optical disc drive 100.

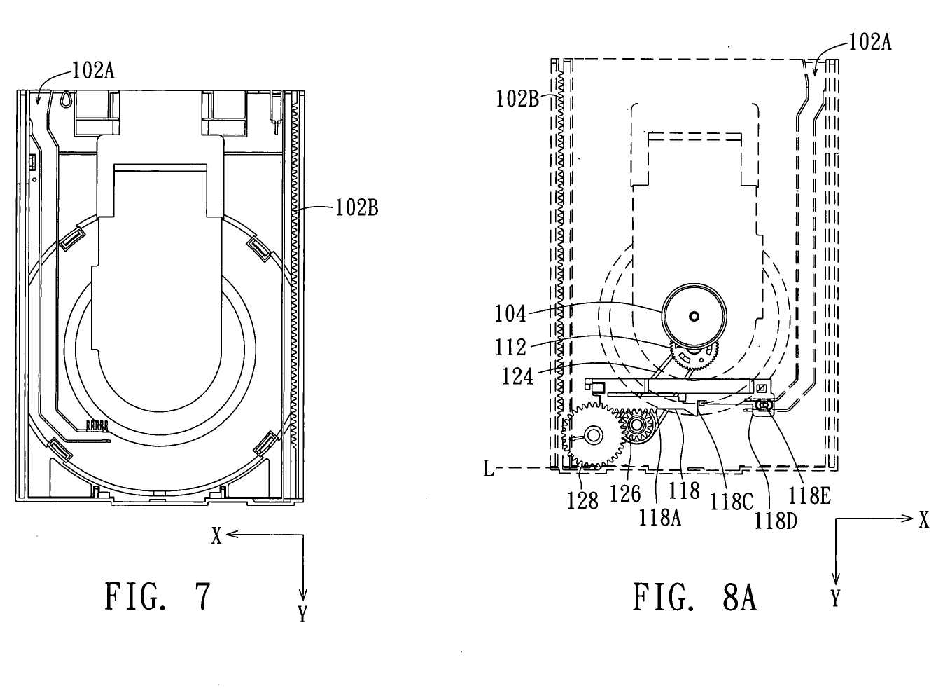

FIG. 7 is a bottom view of the disc transport tray. There are a tray slot 120A and a tray rack 102B formed on the bottom of the tray 102. The tray gear 128 is selectively coupled to the tray rack 102B. When the tray 102 is moved in and out of the optical disc drive 100, the cam block 118E is sliding within the tray slot 102A for driving the cam 118.

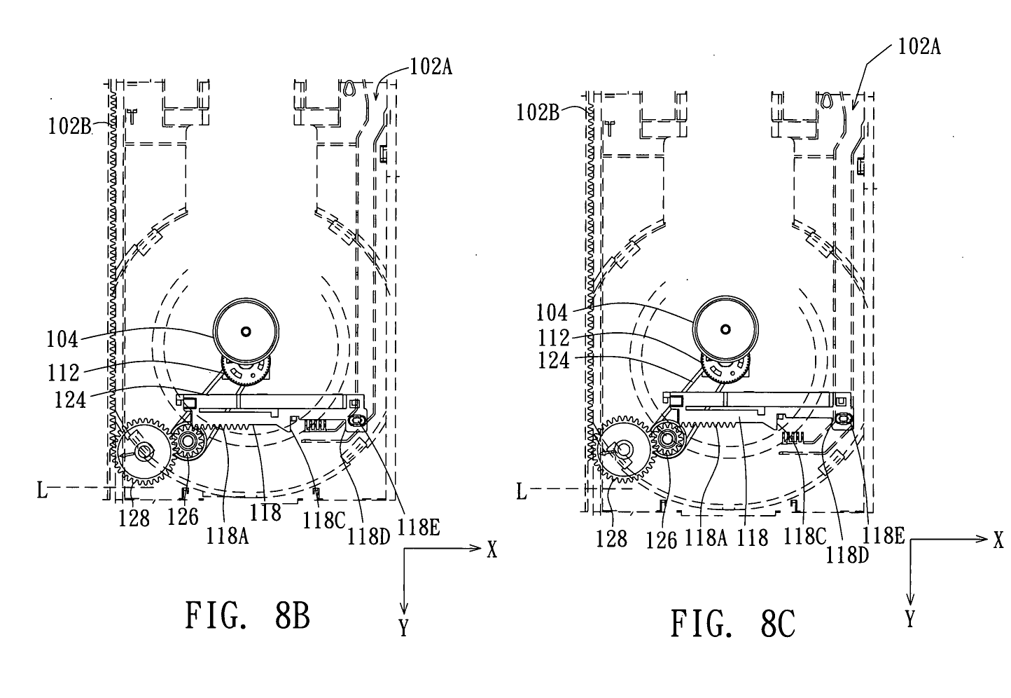

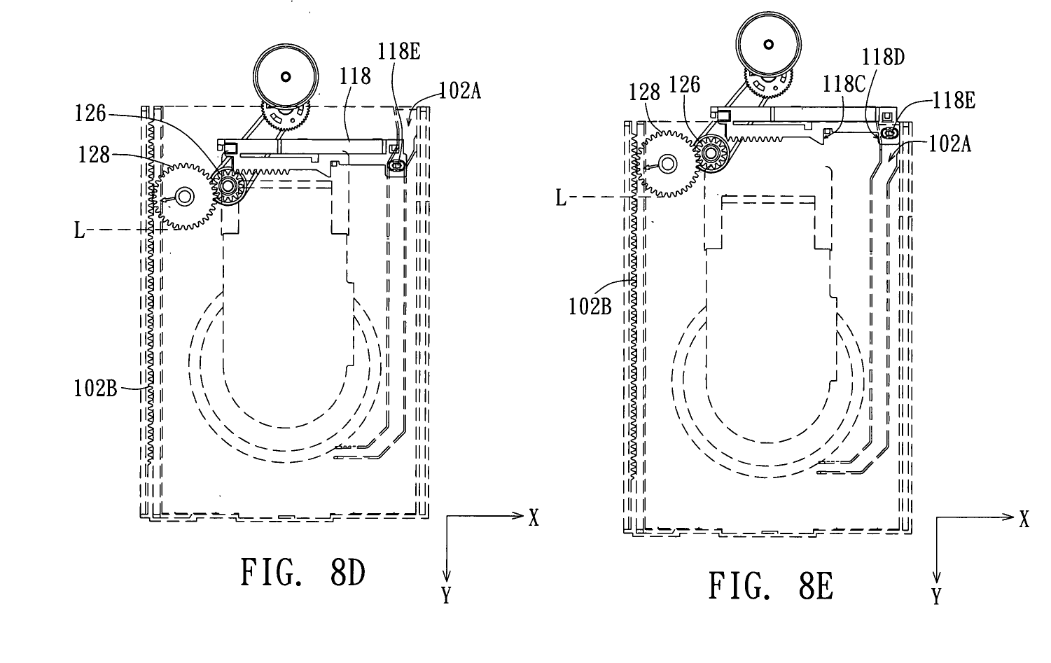

Please refer FIGS. 8A˜8E, illustrating the relative position of the cam block and the tray slot when the tray being moved in or out of the optical disc drive. The straight line L represents the front edge of the optical disc drive. When the user pushes the control button on the board for trying to remove the tray 102 out of the optical disc drive 100, the spindle motor 104 stops operating first (i.e. stop reading/writing information on the disc). Then, the electro-magnet 108 is electrified to attract the gag-bit 106 so as to engage the first gear 110 and the second gear 112. Afterward, the spindle motor 104 restarts to drive the first gear 110; simultaneously, the first gear 110 engages the second gear 112, the second gear 112 drives the shaft 114, the sleeve 116 and the first belt pulley 120. The second belt pulley 122 and the cam gear 126 are rotationally driven by the first belt pulley 120. Meanwhile, the cam block 118E is placed at the first position of the tray slot 102A, as shown in FIG. 8A.

Next, the cam gear 126 engages the cam rack 11 8A to make the cam 118 slide along the direction of X; the rocker-arm 134 and one end of the mounting plate 136 are thus moved downward, and the spindle motor 104 also descend to a lowest position. Meanwhile, the cam block 118E is moved to the second position of the tray slot 102A, as shown in FIG. 8B.

Then, the relative movement between the cam block 118E and the tray slot 102A is generated due to the moving of the cam 118, so that the tray 102 is moved along the direction of Y and the tray gear 128 engages the tray rack 102B. Meanwhile, the cam block 118E is at the third position of the tray slot 102A, and the cam gear 126 disengages from the cam rack 118A, as shown in FIG. 8C. Therefore, the cam gear 126 engages the tray gear 128, and the tray gear 128 engages the tray rack 102B to drive the tray 102 out of the optical disc drive 100. When the tray 102 is out of the optical disc drive 100, the cam block 11 8E is at the fourth position of the tray slot 102A, as shown in FIG. 8D.

After the tray 102 is completely out of the optical disc drive 100, the cam 118 keeps moving along the direction of X (due to the sliding of the cam block 118E in the tray slot 102A) until the first protrusion 118C of the cam 118 trigger the control switch 132, thereby stopping the rotation of the spindle motor 104 and cutting the electricity of the electro-magnet 108. Accordingly, the cam block 11 8E is at the fifth position of the tray slot 102A, as shown in FIG. 8E. Meanwhile, the gag-bit 106 is separated from the electromagnet 106, the shaft 114 is back into the sleeve 116, and the second gear 112 is disengaged from the first gear 110.

When the user press the control button for moving the tray 102 back in the optical disc driver 100, the electro-magnet 108 is electrified, so that the second gear 112 engages the first gear 110 due to the magnetic attraction between the electromagnet 108 and the gag-bit 106. Then, the reverse-rotation of the spindle motor 104 drives the first gear 110; simultaneously, the first gear 110 drives the second gear 112, and the second gear 112 drives the shaft 114, the sleeve 116 and the first belt pulley 120. The second belt pulley 122 and the cam gear 126 are rotationally driven by the first belt pulley 120. Also, the tray gear 128 driven by the cam gear 126 engages the tray rack 102B so as to drag the tray 102 back in the optical disc driver 100. The cam block 118E is at the third position of the tray slot 102A, as shown in FIG. 8C. After the tray 102 is moved into the optical disc driver 100, the moving of the tray 102 generates the relative movement between the cam block 118E and the tray slot 102A, thereby powering the movement of the cam block 118E along the direction of −X so as to make the cam gear 126 engaging the cam rack 118A; meanwhile, the cam block 118E is at the second position of the tray slot 102A, as shown in FIG. 8B. The tray gear 128 is temporary disengaged from the tray rack 102B, and the cam gear 126 engages the cam rack 118A to make the cam 118 sliding along the direction of −X. Therefore, the rocker-arm 134 and one end of the mounting plate 136 are driven upwardly, so that the spindle motor 104 is moved upwardly along the direction of Z.

After the tray 102 completely moves into the optical disc drive 100 and the cam 118 slides in the direction of −X to a limited position, the cam block 118E stops at the first position of the tray slot 102A (as shown in FIG. 8A), and the second protrusion 118D of the cam 118 triggers the control switch 132 to stop the rotation of the spindle motor 104 and cut off the electricity to the electromagnet 108. Meanwhile, the gag-bit 106 is separated from the electro-magnet 106, the shaft 114 is back into the sleeve 116, and the second gear 112 is disengaged from the first gear 110. Afterward, the spindle motor 104 restarts to rotationally drive the disc on the tray 102 for data reading/writing operation.

Furthermore, the rotation speed of the spindle motor 104 for moving the tray 102 in or out of the optical disc drive 100 is much lower than that for rotationally driving the disc on the tray 102 while proceeding data reading/writing operation. When the tray 102 is moved in or out of the optical disc drive 100, the rocker-arm 134 and one end of the mounting plate 136 are going to be driven upwardly, so as the spindle motor 104. Although the spindle motor 104 ascends and reverse-rotates at the same time during the upward movement, it causes no bad effect due to the low rotation speed of the spindle motor 104.

Noted that a control circuit could be applied to control the electricity on/off the electro-magnet 108 and the start/stop of the rotation and reverse-rotation of the spindle motor 104.

According to the aforementioned description, the mechanism design of the invention transmits the rotation power of the spindle motor to the power of the movement of the tray. Thus, the invention of using the spindle motor power the movement of the tray does not require the use of the conventional tray motor, so that the production cost is decreased.

While the invention has been described by way of example and in terms of the preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc drive, at least comprising:
a chassis;
a tray, mounted on the chassis for carrying a disc;
a spindle motor, for rotationally driving the disc;
a transmission chain, for moving the tray; and
a coupling apparatus, selectively coupling the transmission chain and the spindle motor,
when the coupling apparatus is started, the transmission chain is coupled to the spindle motor, and the power generated from the spindle motor is transmitted to the tray through the transmission chain, so as to power the movement of tray for in and out of the optical disc drive.

2. The optical disc drive according to claim 1, wherein the coupling apparatus comprises a magnetic-permeability component and an elecro-magnet, the magnetic-permeability component is coupled to the transmission chain, the electromagnet is coupled to the spindle motor for selectively attracting the magnetic-permeability component; after the electromagnet is electrified, the magnetism exhibits on the electro-magnet attracts the magnetic-permeability component to couple the transmission chain and the spindle motor.

3. The optical disc drive according to claim 2 further comprises a first transmitting component driven by the spindle motor, and the transmission chain further comprises:
a second transmitting component;
a retractable part, coaxially connected to the second transmitting component, and the magnetic-permeability component fixed to one end of the retractable part; and
a driving mechanism, coupled to the retractable part,
when the electromagnet is electrified, the magnetism exhibits on the electro-magnet attracts the magnetic-permeability component to change a length of the retractable part so as to couple the second transmitting component and the first transmitting component; after the spindle motor starts to rotate, the spindle motor drives the first transmitting component, the first transmitting component drives the second transmitting component, the retractable part and the driving mechanism for moving the tray in and out of the optical disc drive.

4. The optical disc drive according to claim 3, wherein the first transmitting component is a first gear, the second transmitting component is a second gear, the magnetic-permeability component is a gag-bit, the retractable part comprises a shaft and a sleeve, the shaft placed within and coaxially rotated with the sleeve is able to slide upward and downward within the sleeve, the gag-bit mounted on one end of the shaft is also used to attach the second gear on the end of the shaft, and the other end of the sleeve is coupled to the driving mechanism;
when the electromagnet is electrified, the electro-magnet attracts the gag-bit so as to pull a part of the shaft off the sleeve and make the second gear engaging the first gear.

5. The optical disc drive according to claim 4 further has a cam for driving the spindle motor to move upward and downward on a direction vertical to the tray, the cam has a cam rack and a bottom of the tray has a tray rack, the driving mechanism comprises a first belt pulley, a second belt pulley, a belt, a cam gear and a tray gear, wherein the first belt pulley is mounted on one end of the sleeve, and the second belt pulley is coupled to the first belt pulley through the belt, the cam gear coupled to the tray gear is coaxially connected to the second belt pulley, the tray gear selectively engages the tray rack, and the cam gear selectively engages the cam rack,
when it is desired to remove the tray out of the optical disc drive, the electromagnet is electrified to attract the gag-bit so as to engage the first gear and the second gear, the spindle motor then starts to drive the first gear, the first gear engages the second gear, the second gear drives the shaft, the sleeve and the first belt pulley, the second belt pulley and the cam gear are rotationally driven by the first belt pulley, the cam gear engages the cam rack to move the cam and descend the spindle motor, then the cam gear engages the tray gear, and the tray gear engages the tray rack to drive the tray out of the optical disc drive;
when it is desired to move the tray back into the optical disc drive, the electromagnet is electrified to attract the gag-bit so as to engage the second gear and the first gear, then the spindle motor is reverse-rotated to drive the first gear, the first gear drives the second gear, the second gear drives the shaft, the sleeve and the first belt pulley, the second belt pulley and the cam gear are rotationally driven by the first belt pulley, the tray gear driven by the cam gear engages the tray rack so as to drag the tray back in the optical disc driver, then the cam gear engages the cam rack to move the cam and ascend the spindle motor.

6. The optical disc drive according to claim 5 further has a control switch, when the tray is completely moved out of the optical disc drive, the cam triggers the control switch to stop the rotation of the spindle motor so as to cut off electricity on the electromagnet; when the tray is completely moved into the optical disc drive, the cam triggers the control switch to stop the rotation of the spindle motor so as to cut off electricity on the electromagnet.

7. The optical disc drive according to claim 6, wherein a tray slot is formed on the bottom of the tray, the cam has a cam block, when the tray is completely moved out of the optical disc drive, the cam block engages and slides within the tray slot until triggering the control switch; when the tray is completely moved into the optical disc drive, the cam block also slides within the tray slot and triggers the control switch.

8. The optical disc drive according to claim 5 further comprises a rocker-arm and a mounting plate, the spindle motor is positioned on the mounting plate and the rocker-arm is coupled to the mounting plate, the movement of the cam makes the swing of the rocker-arm and the mounting plate.

9. A method for moving a tray in-and-out of an optical disc drive by a spindle motor, the optical disc drive comprising a chassis, the tray, the spindle motor, a transmission chain and a coupling apparatus, the tray mounted on the chassis for carrying a disc, the spindle motor used for rotationally driving the disc, the transmission chain used for moving the tray, and the coupling apparatus selectively coupling the transmission chain and the spindle motor, the method comprising steps of:
(a) operating the coupling apparatus, to couple the transmission chain and the spindle motor; and
(b) rotating the spindle motor, to drive the transmission chain, so that the transmission chain driving the tray for moving in-and-out of the optical disc drive.

10. The method according to claim 9, wherein the coupling apparatus comprises a magnetic-permeability component and an elecro-magnet, the magnetic-permeability component is coupled to the transmission chain, the electro-magnet is coupled to the spindle motor for selectively attracting the magnetic-permeability component;
in step (a), when the electromagnet is electrified, the magnetism exhibits on the electro-magnet attracts the magnetic-permeability component to couple the transmission chain and the spindle motor.

11. The method according to claim 10, wherein the optical disc drive further has a first transmitting component driven by the spindle motor, and the transmission chain comprises a second transmitting component, a retractable part and a driving mechanism, the retractable part coaxially connected to the second transmitting component, the magnetic-permeability component fixed to one end of the retractable part, driving mechanism coupled to the retractable part;
in step (a), when the electro-magnet is electrified, the magnetism exhibits on the electromagnet attracts the magnetic-permeability component to change a length of the retractable part so as to couple the second transmitting component and the first transmitting component;
in step (b), after the spindle motor starts to rotate, the spindle motor drives the first transmitting component, the first transmitting component drives the second transmitting component, the retractable part and the driving mechanism for moving the tray in and out of the optical disc drive.

12. The method according to claim 11, wherein the first transmitting component is a first gear, the second transmitting component is a second gear, the magnetic-permeability component is a gag-bit, the retractable part comprises a shaft and a sleeve, the shaft placed within and coaxially rotated with the sleeve is able to slide upward and downward within the sleeve, the gag-bit mounted on one end of the shaft is also used to attach the second gear on the end of the shaft, and the other end of the sleeve is coupled to the driving mechanism;
In step (a), when the electromagnet is electrified, the electro-magnet attracts the gag-bit so as to pull a part of the shaft off the sleeve and make the second gear engaging the first gear.

13. The method according to claim 12, wherein the optical disc drive further has a cam for driving the spindle motor to move upward and downward on a direction vertical to the tray, the cam has a cam rack and a bottom of the tray has a tray rack, the driving mechanism comprises a first belt pulley, a second belt pulley, a belt, a cam gear and a tray gear, wherein the first belt pulley is mounted on one end of the sleeve, and the second belt pulley is coupled to the first belt pulley through the belt, the cam gear coupled to the tray gear is coaxially connected to the second belt pulley, the tray gear selectively engages the tray rack, and the cam gear selectively engages the cam rack;
when it is desired to remove the tray out of the optical disc drive, step (a) comprises: electrifying the electro-magnet to attract the gag-bit so as to engage the first gear and the second gear; step (b) comprises: rotating the spindle motor to drive the first gear, the first gear engaging the second gear, the second gear driving the shaft, the sleeve and the first belt pulley, the second belt pulley and the cam gear rotationally driven by the first belt pulley, the cam gear engaging the cam rack to move the cam and descend the spindle motor, then the cam gear engaging the tray gear, and the tray gear engages the tray rack to drive the tray out of the optical disc drive;
when it is desired to move the tray back into the optical disc drive, step (a) comprises: electrifying the electro-magnet to attract the gag-bit so as to engage the second gear and the first gear; step (b) comprises: reverse-rotating the spindle motor to drive the first gear, the first gear driving the second gear, the second gear driving the shaft, the sleeve and the first belt pulley, the second belt pulley and the cam gear rotationally driven by the first belt pulley, the tray gear driven by the cam gear engaging the tray rack so as to drag the tray back in the optical disc driver, then the cam gear engaging the cam rack to move the cam and ascend the spindle motor.
